(19) United States
(12) Patent Application Publication
(10) Pub. No.: US 2026/0014826 A1
(43) Pub. Date: Jan. 15, 2026

(54) METHOD FOR HEIGHT MEASUREMENT IN A VEHICLE, CONTROL UNIT AND VEHICLE

(71) Applicant: ZF CV Systems Global GmbH, Bern (CH)

(72) Inventors: Oliver Topic, Hannover (DE); Mirko Erich Schaper, Hannover (DE); Pierre De Rochambeau, Bruxelles (BE); Konrad Feyerabend, Hannover (DE); Johann Lucas, Sehnde (DE)

(21) Appl. No.: 19/338,949

(22) Filed: Sep. 24, 2025

Related U.S. Application Data
(63) Continuation of application No. PCT/EP2024/056481, filed on Mar. 12, 2024.

(30) Foreign Application Priority Data
Mar. 24, 2023 (DE) 10 2023 107 482.2

(51) Int. Cl. B60G 17/019; G01B 15/02; G01S 13/08

(52) U.S. Cl. CPC B60G 17/019; G01B 15/02; G01S 13/08; B60G 2401/174; B60G 2500/30

(57) ABSTRACT

A method is for measuring a height in a vehicle with a height adjustment function. A sensor for measuring a height is arranged on the chassis of the vehicle or is connected to the chassis at a defined distance thereto. The sensor is arranged such that distances to an axle of the vehicle and in particular to the ground below the vehicle can be detected. The sensor transmits signals in the direction of the axle and in particular the ground and receives reflected signals and the intensities thereof. The sensor additionally at least indirectly detects the time spans between transmitted signals and reflected signals as signal peaks. The time spans represent the distances of the sensor to the axle and in particular to the ground or can be calculated into the distances.

### CROSS-REFERENCE TO RELATED APPLICATIONS

This application is a continuation application of international patent application PCT/EP2024/056481, filed Mar. 12, 2024, designating the United States and claiming priority from German application 10 2023 107 482.2, filed Mar. 24, 2023, and the entire content of both applications is incorporated herein by reference.

### TECHNICAL FIELD

The disclosure relates to a method for height measurement in a vehicle having height adjustment, wherein a sensor for height measurement is arranged on a chassis of the vehicle or is connected to the chassis at a defined distance, the sensor is arranged in such a way that distances from an axle of the vehicle and in particular also from the ground below the vehicle can be detected and the sensor transmits signals toward the axle, receives reflected signals and at least indirectly records the intensities thereof and also propagation times between transmitted signals and reflected signals as signal peaks, the propagation times representing the distances of the sensor from the axle and in particular also from the ground or being able to be converted into the distances.

The vehicle in question is in particular a vehicle having air suspension, in particular a commercial vehicle. Other types of suspension and vehicle are also possible as long as there is provision for height adjustment.

Furthermore, in particular, the vehicle is equipped with a central control unit for the air suspension or the height adjustment. The control unit may also be part of a brake system.

Furthermore, in particular, the vehicle is a towed vehicle. It may alternatively be a towing vehicle.

Furthermore, in particular, the vehicle is equipped with two or more axles. It may also be a single-axle trailer.

The sensor contains a transmitter and a receiver in one device or is a combination of a transmitter and a receiver, which are matched to one another or connected to one another in terms of circuitry.

### BACKGROUND

Commercial vehicles and automobiles may be provided with height adjustment. The height of the chassis above the axles is then adjustable. In particular, for this purpose, the vehicles are equipped with air suspension system that permits height adjustment.

In order to make a specific height adjustment, it is necessary to detect the current height. In this context, the use of a sensor that is in the form of a transmitter and a receiver, transmits signals toward the axle, receives reflected signals and records the intensities and propagation times thereof as signal peaks is known. If the signal speed is known, the propagation time is also a measure of the distance between the sensor and the axle. When the propagation time is referred to below and in connection with the disclosure, the distance is also meant in particular.

The use of a radar sensor for detecting height is known from EP 4 020 012 A1. In the context of the present disclosure, too, the sensor used is, in particular, a radar sensor.

Radar sensors for distance and motion measurement around a vehicle have already been known for a long time, see, for example, BOSCH Kraftfahrtechnisches Taschenbuch, 27th edition (2011), from page 1154, the section “Sensorik für Fahrerassistenzsysteme”, and subsequent editions.

Radar sensors for distance and motion measurement in the vehicle are also known, for example the AWRL6432 radar sensor from Texas Instruments Incorporated, USA, and the A111 radar sensor from Acconeer AB, Sweden.

The sensor is intended to reliably detect the position of the axle relative to the chassis so as to permit a current distance to be determined between the axle and the chassis. In particular, the sensor is also intended to detect the underlying surface on which the vehicle is moving, that is, the ground.

Radar sensors and sensors of other types have a spatial emission angle for the transmitted signals, for example in conical form or the like. In particular, the sensor is arranged on the chassis in such a way that the axle and/or the ground can be reliably detected. In addition, components that are situated in the emission cone of the signals of the sensor and are also detected may be present on the axle and from the chassis. The signals reflected by these parts, like the signals from the axle and/or the ground, are recorded by the sensor.

### SUMMARY

When the sensor is installed, it is necessary to calibrate it so that the sensor can reliably distinguish the axle and/or the ground from other components. The calibration is intended to proceed as automatically as possible.

According to an embodiment, a method for height measurement is used in a vehicle having height adjustment, wherein a sensor for height measurement is arranged on a chassis of the vehicle or is connected to the chassis at a defined distance, the sensor is arranged in such a way that distances from an axle of the vehicle and in particular also from the ground below the vehicle can be detected and the sensor transmits signals toward the axle, receives reflected signals and at least indirectly records the intensities thereof and also propagation times between transmitted signals and reflected signals as signal peaks, the propagation times representing the distances of the sensor from the axle and in particular also from the ground or being able to be converted into the distances. In particular, the following steps are performed for calibration:
a) different heights of the vehicle are activated by the height adjustment,
b) the propagation times and signal intensities of the reflected signals are ascertained for each height activated in step a), such that a raw signal data set including propagation times and signal intensities of the signal peaks is obtained for each activated height,
c) the propagation times and signal intensities ascertained in step b) are used to identify the signal peaks that always have the same propagation times irrespective of the activated height,
d) the signal peaks identified in step c) that always have identical propagation times together yield a background data set, which is stored for further use.

The method is first used to ascertain for each activated height a raw signal data set including the signal peaks with propagation times and signal intensities. For this purpose, the height can be varied in different ways, for example gradually such that the height is adjusted by one millimeter, one centimeter or another amount each time, in particular by approximately 0.5 mm, in particular starting from a minimum or a maximum. A raw signal data set is created for each selected height.

Continuous adjustment of the height at, for example, one centimeter per second (1 cm/s) is also possible. The sensor can transmit its signals at defined intervals of time and record signal peaks, so that raw signal data sets are generated for different heights.

The raw signal data sets are used to identify the signal peaks that are always identical despite differently selected heights. The identification can be carried out using mathematical methods. Methods for recognizing patterns in data sets are known from a multiplicity of fields of application and need not be explained in more detail here. The identified signal peaks relate to components whose height relative to the chassis is unchanged and which therefore interfere with height measurement. These are, for example, linkages or attachments of another type that are connected to the chassis and are firmly connected to the chassis and situated in the emission cone of the sensor. These signal peaks together yield the background data set, which is stored and can optionally be used in the method.

According to an embodiment of the disclosure, the signal peaks of the background data set are subtracted from the signal peaks of all raw signal data sets such that a corrected signal data set is obtained for each raw signal data set, which is stored. The stored corrected signal data sets can optionally be used in the further method. In addition, the peak data sets may also contain further selected signal peaks. Depending on the selection of the signal peaks, a considerable reduction in the volume of the individual stored signal data sets is possible, which can simplify later processing.

According to an embodiment of the disclosure, signal peaks relating to the axle and in particular also to the ground, namely axle signal peaks and in particular also ground signal peaks, are identified in each corrected signal data set. The corrected signal data sets now contain only the signal peaks of the components that are variable in height relative to the chassis, namely the axle signal peak, in particular the ground signal peak and possibly other signal peaks. Typically, the axle signal peak is the strongest signal peak with a short propagation time, while the ground signal peak is a relatively strong signal peak with a longer propagation time. Owing to the short distance from the sensor and due to the size of the axle, the axle signal peak will often have the highest intensity of all signal peaks. In a workshop environment, the propagation time of the ground signal peak will be the longest. Axle signal peaks and ground signal peaks can thus be determined relatively reliably by way of their signal intensities and propagation times. Corrected signal data sets in which at least the axle signal peak and in particular also the ground signal peak are identified are referred to here as peak data sets.

According to an embodiment of the disclosure, at least the axle signal peaks and in particular also the ground signal peaks of the corrected signal data sets will be stored as peak data sets. In this case, the peak data sets are reduced corrected signal data sets in which at least the axle signal peaks and in particular also the ground signal peaks are identified. In addition, the further signal peaks which may be present can also be stored in the peak data sets. In the extreme case, the signal peaks of the peak data sets correspond to the signal peaks of the corrected signal data sets.

According to an embodiment of the disclosure, the method can include the following steps:
e) multiple or all signal intensities for at least one height of the vehicle are compared with one another in order to determine the highest signal intensity,
f) if the highest signal intensity can be ascertained, it is defined as part of the axle signal peak,
g) if the highest signal intensity cannot be ascertained, the axle is provided with a reflector in order to improve the reflection of the transmitted signals,
h) steps a) to c) are repeated after the reflector has been put on.

The aim is to ascertain the axle signal peak. If one signal peak stands out clearly from the other signal peaks, it is probably the axle signal peak. A clear difference does not exist, for example, when the two highest signal peaks have identical or only slightly different signal intensities. What is slight in this regard can be defined by parameters. If no axle signal peak can be ascertained in this way, the method is interrupted and the axle is provided with the reflector in order to improve the reflection such that the signal intensity of the axle signal peak is increased. The described steps e) to g) are repeated after the reflector has been put on. If an axle signal peak is now recognizable, the method is continued. The fact that a highest signal intensity cannot be ascertained can be indicated, for example, via a signal that can be recognized by operators.

According to an embodiment of the disclosure, the highest signal intensity selected can be that which is higher than any other compared signal intensity by at least a defined amount. The defined amount is in particular an absolute amount or a defined fraction of the signal intensity which is smaller or higher each time in comparison, for example 5% or 10%. The intensity is itself defined in particular as the ratio of the received reflected signal to the transmission signal and can be specified in percent.

According to an embodiment of the disclosure, the ground signal peak selected can be the signal intensity that has a higher propagation time than the axle signal peak by a defined amount and in particular is also higher than adjacent signal intensities by a defined amount. Due to the known diameter of the wheels on the axles, the difference in the propagation times between the ground signal peak and the axle signal peak is known within relatively narrow limits. A minimum and a maximum can be specified as the defined amount of the higher propagation time. Moreover, it can be expected that the ground, on account of its surface, provides a reflected signal having a relatively high signal intensity. If components arranged on the axle and running beneath same also provide reflected signals, the signal intensities thereof ought to be lower. The ground signal peak can be reliably ascertained as a result of the cited constraints.

According to an embodiment of the disclosure, vertical distances from the axle can be calculated from the axle signal peaks by linearization and stored. For the calibration, the propagation times representing the different distances can be expected, provided that only the axle signal peak is of interest. However, if the axle signal peak and the ground signal peak are compared with one another, linearization of the axle signal peak can be expedient. The reason for this is the chassis geometry with the suspension of the axle. The axle is held, for example, on longitudinal control arms and is supported by air springs. A height adjustment results in the axle moving along a partial circular path, that is, with a vertical and a horizontal component, both of which are variable.

Moreover, the sensor is often not mounted vertically above the axle. Consequently, the propagation time of the axle signal peak cannot be directly converted into the vertical distance between a horizontal plane of the axle and a horizontal plane of the sensor. Rather, the position of the sensor and the partial circular movement of the axle need to be taken into account. This is referred to here as linearization. The result of the linearization is the vertical axle distances, that is, the vertical distances between the plane of the axle and the plane of the sensor. Linearization is easily possible with knowledge of the chassis geometry and the arrangement of the sensor relative to the axle and need not be explained in detail here.

The peak data sets already mentioned can contain the vertical distances from the axle that were ascertained by the linearization for the axle signal peaks in addition to or instead of the propagation times/distances. Alternatively, linearized peak data sets are created from the existing peak data sets by the linearization and stored. In this case, the linearized peak data sets can replace the existing peak data sets or can be stored in addition. Whether linearization is expedient can be assessed on the basis of the divergences between the peak data sets and the linearized peak data sets that occur in practice for a specific vehicle.

According to an embodiment of the disclosure, two or more different heights are activated for calibration, in particular continuously or cyclically. Just two different heights can be used to ascertain the background data set. In particular, more different heights are activated.

According to an embodiment of the disclosure, at least a minimum height and a maximum height of the vehicle are activated for calibration. At least for the minimum height and the maximum height of the vehicle, the chassis geometry can be used to determine the theoretical distances between the ground and the sensor and between the axle and the sensor, and so an additional check on the plausibility of the data obtained is initiated here.

According to an embodiment of the disclosure, all heights from a minimum height of the vehicle to a maximum height of the vehicle or vice versa can be activated for calibration. For example, the air springs are first deflated and then gradually or continuously inflated until the maximum height is reached. The range from the minimum to the maximum height then defines the measurement range within which the calibration is performed.

According to an embodiment of the disclosure, the sensor used can be a radar sensor. The radar sensor is less susceptible to soiling than an optical transceiver. In particular, the radar sensor operates using the FMCW (Frequency Modulation Continuous Wave) method or the PCR (Pulse Coherent Radar) method. In particular, the radar sensor can operate in a frequency range from 50 GHz to 100 GHz, in particular at approximately 60 GHz or approximately 77 GHz. The emission angle may be 10° to 30° in particular. Alternatively, other sensor technologies can be used, for instance ultrasonic sensors or lidar sensors, in particular sensors having an acute emission angle.

According to an embodiment of the disclosure, when peak data sets exist and a background data set exists, there can be provision for the following steps after the vehicle is started:
at least one current raw signal data set is created,
an associated current peak data set is calculated by subtracting the existing background data set from the current raw signal data set,
the current axle signal peak within the current peak data set is identified by comparing the current peak data set with the existing peak data sets or by selecting the highest current signal peak.

Starting the vehicle is defined as in particular turning on an ignition or operating a starting button. The peak data sets and the background data set must already exist. The peak data sets can also be the linearized peak data sets. After the vehicle has been started, the sensor is automatically active and generates a new raw signal data set, which is referred to as the current raw signal data set and, in particular, is cyclically renewed. The aim is to determine the current axle signal peak and thus to ascertain the current vehicle height. For this purpose, the existing background data set is subtracted from the current raw signal data set and in this way a current corrected signal data set and a current peak data set are calculated. The current axle signal peak is ascertained by comparing the current peak data set with the existing peak data sets or by selecting the highest current signal peak. The propagation time of the current axle signal peak can be used to indicate the current vehicle height. While the vehicle is operating, the steps are automatically repeated cyclically or on demand. The steps are performed in particular in a program-controlled manner.

According to an embodiment of the disclosure, a current vertical distance from the axle can be calculated from the propagation time of the current axle signal peak by linearization. Depending on the chassis geometry and the arrangement of the sensor, the vertical distance and thus also the current vehicle height can diverge from the distance between the sensor and the axle.

According to an embodiment of the disclosure, the identified current axle signal peak can be checked for plausibility by way of the following measures:
checking whether the current peak data set has a ground signal peak that matches the identified current axle signal peak in terms of its propagation time and/or its signal intensity, or
checking whether the current peak data set has other signal peaks that match the identified current axle signal peak in terms of their propagation times and/or their signal intensities.

The ground signal peak must be at a certain distance from the axle signal peak, this distance being able to be subject to only small fluctuations. In addition, the current ground signal peak must match the same existing peak data set as the current axle signal peak. The same applies to other current signal peaks of the current peak data set. If no plausibility is established during the check, an error message can be output.

According to an embodiment of the disclosure, depending on the outcome of the check for plausibility, a different current signal peak can be selected as the current axle signal peak or the steps specified earlier are repeated, in particular for a different height of the vehicle.

The disclosure also relates to a sensor for height measurement in a vehicle, having software for carrying out the method according to the disclosure. Sensors as integrated components may be equipped with a processor, a memory and a user-programmable area for processing the ascertained data, see also the radar sensors mentioned at the outset for distance and motion measurement in the vehicle.

The disclosure also relates to a control unit having software for carrying out the method according to the disclosure. The control unit receives the data from the sensor and controls the sensor. In addition, the control unit regulates the height adjustment of the vehicle, for example by activating air springs, or transfers data to another control unit for height adjustment and/or control of the air suspension.

Finally, the disclosure also relates to a vehicle having height adjustment, a chassis, at least one axle, a sensor according to various embodiments of the disclosure or a sensor for height measurement and a control unit according to various embodiments of the disclosure.

### BRIEF DESCRIPTION OF DRAWINGS

The invention will now be described with reference to the drawings wherein:

FIG. 1 shows a bottom view of a vehicle having three axles;

FIG. 2 shows the vehicle according to FIG. 1 in a vertical section to illustrate the axle with a sensor for height measurement;

FIG. 3 shows the sensor and the axle to explain height measurement by recording the propagation time of reflected signals;

FIG. 4 shows signal peaks of reflected signals with intensities over distances within the scope of a first measurement;

FIG. 5 shows signal peaks of reflected signals with intensities over distances within the scope of a second measurement;

FIG. 6 shows signal peaks of reflected signals with intensities over distances within the scope of a third measurement;

FIG. 7 shows signal peaks, ascertained from the measurements according to FIGS. 4 to 6, of fixed points on the chassis as a so-called background map;

FIG. 8 shows the signal peaks according to FIG. 4 minus the background map according to FIG. 7;

FIG. 9 shows the signal peaks according to FIG. 5 minus the background map according to FIG. 7; and,

FIG. 10 shows the arrangement of the sensor relative to the axle and the movement of the axle along a partial circular path to explain the difference between the distance between the sensor-axle on the one hand and the vertical axle distance on the other hand.

### DETAILED DESCRIPTION

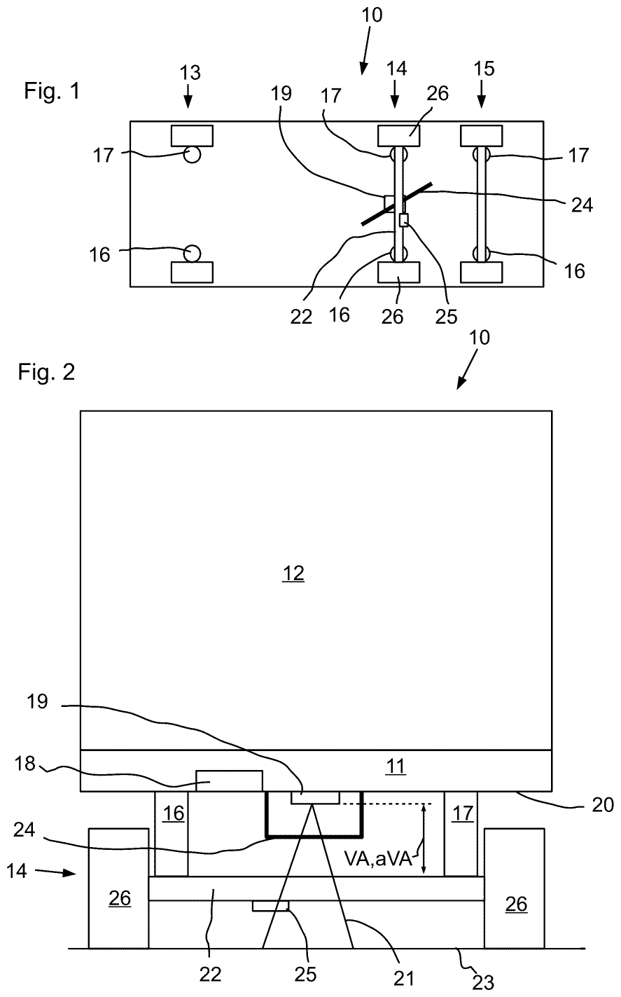

Reference is first made to FIGS. 1 and 2. A vehicle 10 having a chassis 11, a superstructure 12 and three axles 13, 14, 15 is height-adjustable by way of air springs 16, 17. Specifically, a vertical distance VA between the axles 13, 14, 15 and the chassis 11 situated above it is adjustable by adjusting the air springs 16, 17. Such vehicles have been developed and used for decades for different purposes, in particular as commercial vehicles, including for transporting goods and/or persons. In particular, they are driven vehicles. They may alternatively be towed vehicles.

Modern vehicles of the type mentioned have an electronic control unit 18 for the air suspension. The control unit 18 may be connected to or part of a brake control unit.

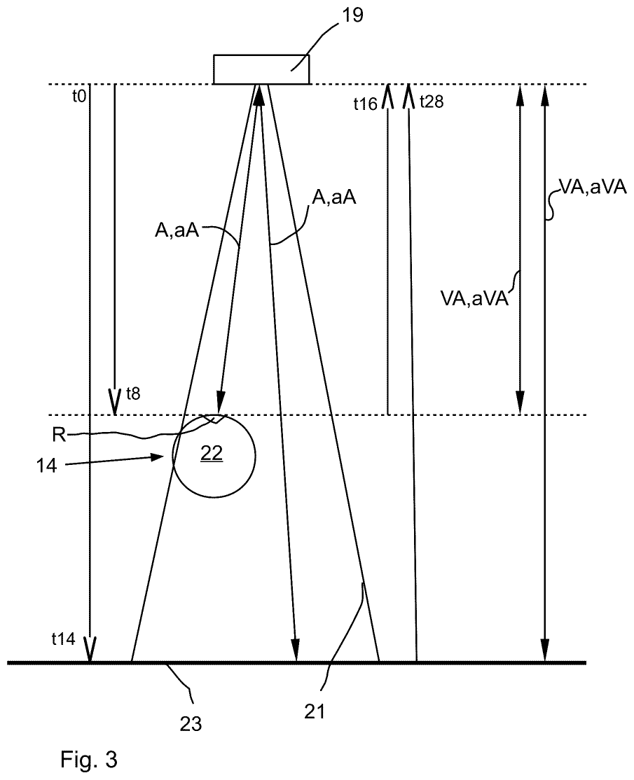

As an input variable for controlling the height adjustment, the control unit 18 requires information about the current vertical distance aVA, or alternatively about the current distance aA (FIG. 3 only). This information is provided by a sensor 19 on an underside 20 of the chassis 11. The sensor 19 here is a radar sensor, which is connected to the control unit 18 in a manner not shown in any more detail and which is a component that is known per se. If the sensor 19 projects downward beyond the chassis 11, the vertical distance VA, aVA relates in particular to the sensor 19, as can be seen from FIG. 2.

Different sensor types that are already available or are still being developed can be used as radar sensors. In particular, a frequency range of approximately 60 GHz can be used.

In particular, a radar sensor of the FMCW (Frequency Modulation Continuous Wave) type is used as the sensor 19 here. Radar sensors of this type are used in the automotive sector for distance measurement and for interior monitoring. By way of example, the AWRL6432 radar sensor from Texas Instruments can be used for the present method for height measurement.

Alternatively, a radar sensor operating according to the principle of the pulsed radar can be used, in particular a pulsed coherent radar sensor. Such a radar sensor is, for example, the A111 pulsed coherent radar (PCR) sensor from Acconeer.

The sensor 19 detects objects in a substantially conical, downwardly directed region—in its emission cone—which is referred to here as the signal cone 21 and has a beam angle of in particular 10° to 30°. Primarily, an axle tube 22 of the axle 14 below the sensor 19 is detected. At the same time, the signal cone 21 also covers a navigable surface below the axle 14, referred to here as the ground 23.

Similar sensors 19 are installed in differently configured vehicles. In particular, the vertical distance VA between the underside 20 and the axle tube 22 can vary independently of the height adjustment provided in any case. Calibration is therefore necessary when the sensor 19 is installed and first put into operation. The calibration is intended to be able to be performed automatically as far as possible. This would be relatively simple if the sensor 19 could detect only the axle 14 and the ground 23. In practice, there may be, under the chassis 11 and in the region of the axles 13 to 15, additional parts or attachments that are also in the region of the signal cone 21 and are also detected. By way of illustration, FIGS. 1 and 2 show a linkage 24 beneath the sensor 19 and an attachment 25 on the axle 14. The linkage 24 and the attachment 25 are situated, as can be seen, in the region of the signal cone 21.

The distance measurement by the sensor 19 is explained below with reference to FIG. 3. For the sake of simplicity, only the sensor 19, the axle tube 22 of the axle 14 and the ground 23 are shown. A reflector (R) facing the sensor (19) may be arranged on the axle tube (22).

A radar signal having the signal cone 21 is emitted by the sensor 19 at the time t0. The radar signal reaches the axle tube 22 at the time t8 and the ground 23 at the time t14. Signals—not shown—reflected by the axle tube 22 and the ground 23 reach the sensor 19 at the times t16 and t28 and are detected there. The times t8, t14, t16, t28 are only abstract units of time in relation to t0 and are intended to illustrate that the signal reflected by the ground 23 arrives at the sensor 19 significantly later than the signal reflected by the axle tube 22, in the case of a common signal emitted by the sensor 19. In this case, each time t16, t28 is a propagation time in relation to the time to and also a measure of the distance A between the sensor and the axle (t16-t0) and the sensor and the ground (t28-t0). A propagation time of 1 ns corresponds to a signal path of approximately 30 cm and thus to a distance of approximately 15 cm. For the sake of simplicity, reference is made below only to the distance and not to the propagation time.

The reflected signals are not uniform, but rather have different intensities. The intensity I depends at least on the nature of the detected object and on the distance A. Each reflected signal therefore has an individual intensity I in addition to the individual value for the distance A. The intensity I and the distance A can be combined under the term signal peak, are characteristic data thereof and are made available by the sensor 19 for calculations and the further processing in the vehicle or are processed in the sensor 19.

The aforementioned reflected signals are signals received by the sensor 19, produced by reflection of a transmitted signal. Depending on the technology used, the sensor 19 transmits individual signals with subsequent pauses, and so the reflected signals can be reliably received within the pauses. Alternatively, the sensor 19 transmits a continuous signal that is cyclically modulated. The reflected signals then also have the modulations, but at different times.

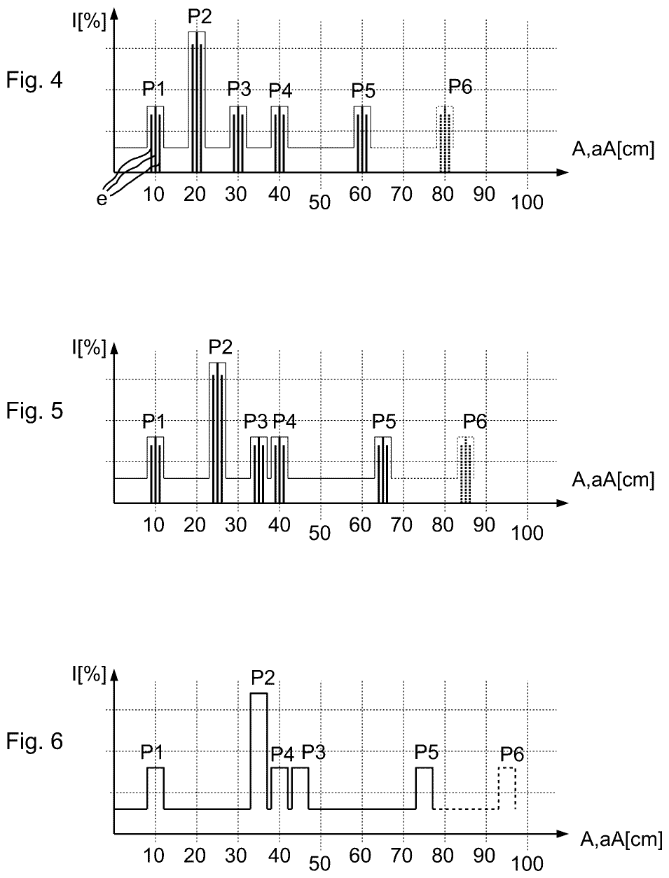

FIG. 4 uses a graph to show the intensities I over distances A of signal peaks P1 to P6 for a single transmitted signal. These may also be signal peaks for a plurality of transmitted signals, the mean values of the signal peaks having been determined. Signal peaks P1 to P6 relate to the following parts:
P1 signal peak of a component that is arranged on the chassis 11 in an immobile manner, for example the linkage 24,
P2 signal peak of the axle 14, namely the axle tube 22,
P3 signal peak of a component that is connected to the axle 13 in an immobile manner, for example the attachment 25,
P4 signal peak of a further component that is connected to the chassis 11 in an immobile manner, which is not shown in the figures,
P5 signal peak of the ground 23,
P6 signal peak of a depression in the ground 23, for example a pothole (not shown).

As shown in FIGS. 4 and 5, each signal peak P1-P6 is the maximum of a series of adjacent individual peaks e. Each signal transmitted by the sensor 19 yields multiple reflected signals, depending on the shape and structure of a surface covered by the radar beam. For the sake of simplicity, FIGS. 4 and 5 depict three individual peaks for each signal peak, and FIGS. 6 to 9 show no individual peaks. The number and distribution of the individual peaks and the distances of the individual peaks from one another can be quite different, unlike in the figures. What is important is the maximum of the individual peaks e. The maximum yields the associated signal peak P1 to P6.

The possible calibration of the sensor 19 is explained below with reference to FIGS. 4 to 10:

After the sensor 19 has been fitted to the chassis 11, a series of measurements are performed. The results of the measurements are evaluated. The evaluation is stored and is used or made available for measurements that are to be performed while the vehicle is operating.

For the series of measurements, the height adjustment of the vehicle 10 goes through a so-called calibration pass. That is, that the air springs 16, 17 are activated gradually or continuously such that the height adjustment goes through its entire range from minimum to maximum, or vice versa. Depending on the desired resolution of the different heights, more or fewer measurements with the sensor 19 are performed during the calibration pass, and the signal peaks are stored as a raw signal data set.

FIGS. 4 to 6 show the signal peaks of three different measurements by way of illustration. Each of FIGS. 4 to 6 corresponds to a raw signal data set for a specific height. The raw signal data set contains the intensity I and the distance A for each signal peak.

FIG. 4 shows the signal peaks of a first measurement with the chassis 11 at the minimum height above the axle 14, corresponding to a distance A between the axle tube 22 and the sensor 19 of, for example, 20 cm here. This can be seen from the signal peak P2 at the position A=20 cm. In addition, the further signal peaks P1, P3, P4, P5, P6 at other positions a are recorded. P5, as the signal peak of the ground 23, is at the position A=60 cm, that is, 40 cm further away from the sensor 19 than the signal peak P2 of the axle 14. The signal peak P6 shown in dashed lines is another 20 cm away again and does not occur in a calibration pass in a controlled workshop environment with level ground. When later driving, the signal peak P6 can indicate a pothole, for example.

FIG. 5 shows the signal peaks of a measurement with the axle 14 at a distance that is 5 cm greater compared to FIG. 4, that is, with the signal peak P2 at the position A=25 cm. Correspondingly, the signal peaks P3, P5 and P6 are also shifted by 5 cm.

FIG. 6 shows the signal peaks of a measurement with the axle 14 at a distance that is 15 cm greater compared to FIG. 4, that is, with the signal peak P2 at the position A=35 cm. Correspondingly, the signal peaks P3, P5 and P6 are also shifted by 15 cm.

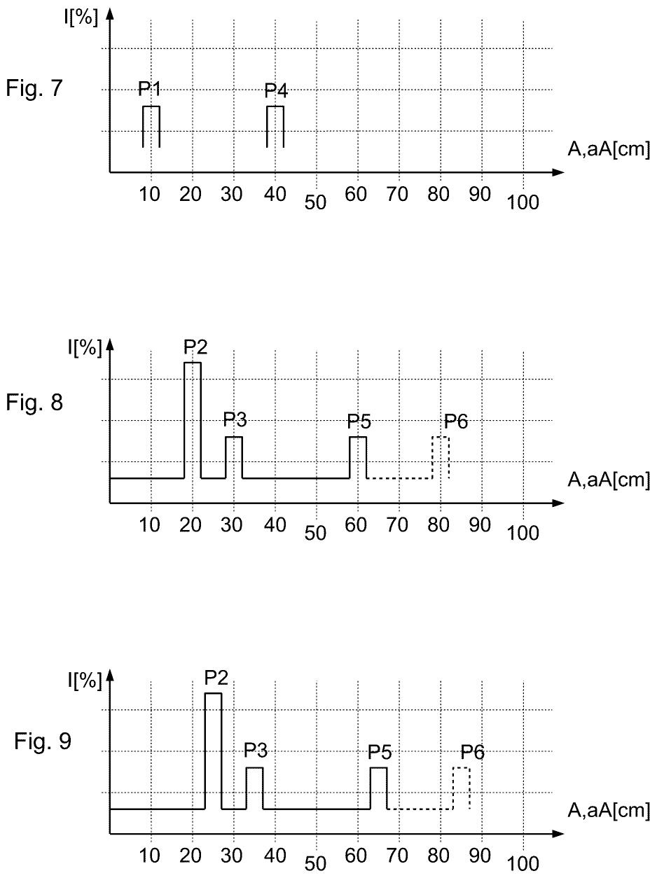

When comparing FIGS. 4 to 6, the signal peaks P1 and P4 stand out. They are always at the same distance A, despite the height adjustment. They must therefore be reflected signals from components that are connected to the chassis 11 in an immobile manner. Since the signal peaks P1, P4 are constant, they can be ascertained simply by comparing the raw signal data sets and are shown in isolation in FIG. 7.

The signal peaks P1, P4 interfere with the height measurement via the radar sensor and are therefore referred to as background and in FIG. 7 as a background data set. The signal peaks P1, P4 of the background data set are subtracted from all raw signal data sets produced during the calibration pass. This operation yields a corrected signal data set for FIG. 4, as shown in FIG. 8 by the remaining signal peaks P2, P3, P5. Analogously thereto, FIG. 5 yields the corrected signal data set, as shown in FIG. 9. In this way, a dedicated corrected signal data set, which no longer contains the signal peaks of the background data set, is produced for each height detected during the calibration pass.

The corrected signal data sets can be purged of signal peaks that are not relevant to the further considerations. Corrected signal data sets cleaned up in this way are referred to here as peak data sets. The peak data sets contain at least the signal peaks P2 for the axle 14 and in particular additionally the signal peaks P5 for the ground. Advantageously, selected further signal peaks are retained. This can facilitate plausibility checks. It is also possible to maintain all signal peaks of the corrected signal data sets. The latter are then also the peak data sets. Example of a peak data set:

Measurement for minimum air suspension (analogous to FIG. 4)

| Included | | | |
|---|---|---|---|
| signal peaks | P2 | P3 | P5 |
| Intensities I | 35 | 16 | 16 |
| Distances A | 20 | 30 | 60 |

| | | |
|---|---|---|
| Peak names | axle signal | ground signal |
| | peak | peak |

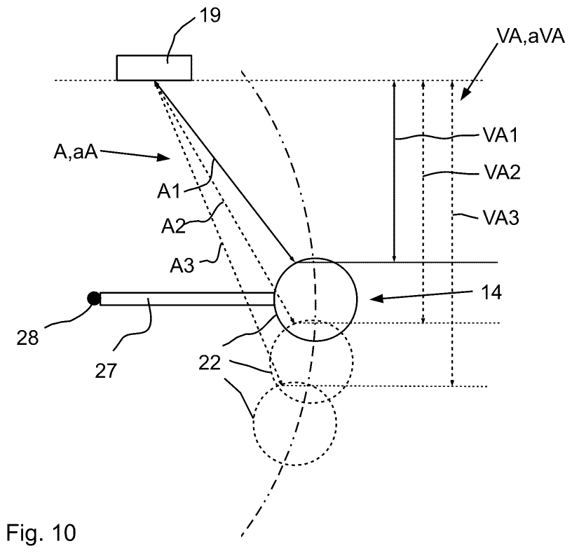

Theoretically, the signal peaks P2 and P5 for the axle 14 and the ground 23 should change in sync with one another during the calibration pass as long as the pressure in the tires 26 does not fluctuate. In fact, the distance A may still vary for another reason. As shown in FIG. 10, the axle 14 is suspended in an articulated manner, specifically here on longitudinal control arms 27 that pivot about a pivot point 28. Depending on the chassis geometry and the arrangement of the sensor 19, a relevant effect can result.

In the example shown, a shortest distance A1 between the sensor 19 and the axle tube 22 is assumed. The axle tube 22 is not vertically beneath the sensor 19. A vertical distance VA1 between the sensor 19 and the axle tube 22 is therefore significantly shorter. As the height increases in the course of the calibration pass, the axle tube 22 occupies other positions, for example at the distances A2 and A3 and corresponding vertical distances VA2 and VA3. On account of the specified conditions, the vertical distances VA1, VA2, VA3 differ from the distances A1, A2, A3 and moreover have different relative distances. It may therefore be expedient to convert the distances A included in the corrected peak data sets into the associated vertical distances VA on the basis of the known chassis geometry and the arrangement of the sensor 19. The peak data sets generated in this way are referred to here as linearized peak data sets and can be used instead of or in addition to the peak data sets. The conversion—linearization—of distances into vertical distances is disclosed for example in EP 4 020 012 A1.

The linearization of the signal peaks can also take place at an earlier time, namely as soon as it is established which signal peak belongs to the axle 14.

Before the calibration pass, it is unclear which signal peaks will belong to the axle 14 and to the ground 23. In principle, it is assumed that the signal peak of the axle 14 will have the greatest intensity of all signal peaks, since the axle tube 22 is relatively large and is at only a short distance from the sensor 19. However, the surface of the axle tube 22 is curved, and so the reflected signal is less intense than in the case of a flat surface. To ensure that the axle 14 generates the highest signal peak, it may therefore be expedient to put the radar reflector R on the axle tube 22. This can be ascertained via a preliminary experiment.

The intensity of the signal peak for the ground 23 should be somewhat lower, but still very distinct, at least in a controlled workshop environment with level ground 23. Moreover, in a controlled workshop environment, no signal peaks ought to occur that are at a greater distance A than the signal peak of the ground 23. With these precautions and considerations, at least the signal peaks P2, P5 for the axle 14 and the ground 23 can be identified from the measurements during the calibration pass. All other signal peaks relate either to attachments or to the aforementioned background.

The signal peaks P1, P4 that belong to the background can be determined by evaluating the raw signal data sets ascertained during the calibration pass. At least some of the non-relevant signal peaks outside the background data set can be excluded via a size comparison. For example, only the highest five signal peaks P1 to P5 are already captured in the raw signal data sets during the calibration pass, but not signal peaks with a lower intensity. Alternatively, signal peaks with a lower intensity are excluded only from the corrected signal data sets, the peak data sets or from the linearized peak data sets.

After the entire calibration process has been completed, the background data set and also the peak data sets and/or the linearized peak data sets are stored and can later be used when driving to determine a respective current height of the vehicle. In the stored peak data sets, the signal peaks P2 for the axle 14 can be identified and noted as such. In addition to the data for the intensity I and the distance A, each signal peak in the peak data sets may also include the information “axle signal peak”, if applicable. Analogously, the signal peak P5 for the ground 23 may additionally include the information “ground signal peak”.

After the calibration has been completed, a current height is intended to be continually ascertained when later driving. To this end, the sensor 19 is used to cyclically record current signal peaks and generate current peak data sets. The current height may relate to a distance between the chassis 11 and the axle 14, a distance between the chassis 11 and the ground 23, or other distances that vary during the height adjustment of the vehicle 10. Since the distances can simply be converted into one another, the current distance aA between the sensor 19 and the axle 14 or the current vertical distance aVA is assumed to be the current height here for the sake of simplicity. The current distance aA is included in or derivable from each current signal peak of the axle 14. Within a current peak data set, in particular the highest current signal peak is assumed to be the current signal peak of the axle 14.

Alternatively, the current signal peak of the axle 14 can be ascertained from the relative position with respect to other current signal peaks, in particular relative to the current signal peak of the ground 23 or relative to other current signal peaks. The relative position of the current signal peaks of the current peak data set under consideration must correspond to the relative position of the signal peaks in one or more of the stored peak data sets. By comparing the current peak data set against the stored peak data sets, the most suitable stored peak data set can be ascertained. From this, the signal peak for the axle 14, in particular also the signal peak for the ground 23 and/or other signal peaks, are known and can be adopted as current signal peaks. At least, the current signal peak for the axle 14 can be identified by comparing the peak data sets against the current peak data set.

After the current signal peak of the axle 14 has been identified, the current distance aA between the sensor 19 and the axle 14 can be determined. The current vertical distance aVA can either be calculated from the current distance aA taking into account the vehicle geometry and the arrangement of the sensor 19 on the chassis 11 or can be determined using the linearized peak data sets.

The method steps of an illustrative calibration pass and of the later driving are reproduced as bullet points below.

Installation of the sensor 19 with calibration pass:
the sensor 19 is mounted on the chassis 11;
the sensor 19 is switched on;
the sensor 19 generates first raw signal data set;
optionally: the highest signal peak is determined as the axle signal peak P2;
calibration pass to generate all desired raw signal data sets;
comparison of the raw signal data sets to determine the background data set;
generate the corrected signal data sets and peak data sets;
determine axle signal peaks P2 and ground signal peaks P5;
optionally: define the measurement range for height adjustment;
generate linearized peak data sets.

Driving after calibration of the sensor 19:
vehicle 10 ignition or power supply on;
the sensor 19 generates the current raw signal data set;
the background data set from the calibration pass is used to generate the current peak data set;
the highest current signal peak is determined as the current axle signal peak P2 or
to determine the current axle signal peak P2, the current peak data set is compared with peak data sets from the calibration pass;
optionally: the axle signal peaks P2 and ground signal peaks P5 of the peak data sets from the calibration pass are used for plausibility checking;
optionally: other signal peaks from the calibration pass are used for plausibility checking;
linearize the axle signal peak P2;
cyclically repeat the preceding steps.

It is understood that the foregoing description is that of the preferred embodiments of the invention and that various changes and modifications may be made thereto without departing from the spirit and scope of the invention as defined in the appended claims.

### List of Reference Signs as Part of the Description

10 vehicle
11 chassis
12 superstructure
13 axle
14 axle
15 axle
16 air springs
17 air springs
18 control unit
19 sensor
20 underside
21 signal cone
22 axle tube
23 ground
24 linkage
25 attachment
26 tire
27 longitudinal control arm
28 pivot point
aA distance
A current distance
A1 distance
A2 distance
A3 distance
aVA current vertical distance
e individual peaks
I intensity
P1 signal peak
P2 signal peak
P3 signal peak
P4 signal peak
P5 signal peak
P6 signal peak
R reflector
T0 time
T8 time
T14 time
T16 time
T28 time
VA vertical distance
VA1 vertical distance
VA2 vertical distance
VA3 vertical distance

1. A method for height measurement in a vehicle having a height adjustment, wherein a sensor for height measurement is arranged on a chassis of the vehicle or is connected to the chassis at a defined distance, the sensor is arranged such that distances from an axle of the vehicle and from a ground below the vehicle can be detected, the method comprising:
via the sensor, transmitting signals toward the axle and the ground, receiving reflected signals and at least indirectly recording intensities of the reflected signals and propagation times between the transmitted signals and the reflected signals as signal peaks, wherein the propagation times represent the distances of the sensor from the axle and also from the ground or can be converted into the distances;
the method, for calibration, further comprising:
activating different heights of the vehicle by the height adjustment;
ascertaining the propagation times and the signal intensities of the reflected signals for each height activated in said activating different heights, such that a raw signal data set including the propagation times and the signal intensities of the signal peaks is obtained for each activated height;
identifying the signal peaks that always have the same propagation times irrespective of the activated height via the ascertained propagation times and signal intensities;
storing a background data set yielded from the identified signal peaks that always have identical propagation times.

2. The method of claim 1, wherein the signal peaks of the background data set are subtracted from the signal peaks of all raw signal data sets such that a corrected signal data set is obtained for each raw signal data set, which is stored.

3. The method of claim 2, wherein signal peaks relating to the axle and also to the ground, namely axle signal peaks and ground signal peaks, are identified in each corrected signal data set.

4. The method of claim 3, wherein at least the axle signal peaks and the ground signal peaks of the corrected signal data sets are stored as peak data sets.

5. The method of claim 3, wherein determining the axle signal peaks includes:
comparing multiple or all signal intensities for at least one height of the vehicle with one another in order to determine a highest signal intensity;
if the highest signal intensity can be ascertained, defining the highest signal intensity as part of the axle signal peaks;
if the highest signal intensity cannot be ascertained, the axle is provided with a reflector in order to improve the reflection of the transmitted signals; and,
repeating said activating different heights of the vehicle by the height adjustment, said ascertaining the propagation times and signal intensities of the reflected signals, and said identifying signal peaks that always have the same propagation times irrespective of the activated height via the ascertained propagation times and signal intensities, are repeated after the reflector has been put on.

6. The method of claim 5, wherein the highest signal intensity selected is that which is higher than any other compared signal intensity by at least a defined amount.

7. The method of claim 5, wherein part of the ground signal peaks selected is the signal intensity that has a higher propagation time than the axle signal peaks by a defined amount and is also higher than adjacent signal intensities by a defined amount.

8. The method of claim 4, wherein vertical distances from the axle are calculated from the propagation times of the axle signal peaks by linearization and stored.

9. The method of claim 1, wherein two or more different heights are activated for calibration.

10. The method of claim 1, wherein at least a minimum height and a maximum height of the vehicle are activated for calibration.

11. The method of claim 1, wherein all heights from a minimum height to a maximum height of the vehicle or vice versa are activated for calibration.

12. The method of claim 10, wherein the propagation time of an axle signal peak with the vehicle at the minimum height and the propagation time of the axle signal peak with the vehicle at the maximum height define a measurement range, which is stored.

13. The method of claim 1, wherein the sensor is a radar sensor.

14. The method of claim 1, wherein when a peak data set exists and a background data set exists, and after the vehicle is started, the method further comprises:
creating at least one current raw signal data set;
calculating an associated current peak data set by subtracting the existing background data set; and,
identifying a current axle signal peak within the current peak data set by comparing the current peak data set with the existing peak data set or by selecting the highest current signal peak.

15. The method of claim 14, wherein a current vertical distance from the axle is calculated from the propagation time of the current axle signal peak by linearization.

16. The method of claim 14, wherein the identified current axle signal peak is checked for plausibility by:
checking whether the current peak data set has a current ground signal peak that matches the identified current axle signal peak in terms of at least one of its propagation time and its signal intensity; or,
checking whether the current peak data set has other current signal peaks that match the identified current axle signal peak in terms of at least one of their propagation times and their signal intensities.

17. The method of claim 16, wherein, depending on an outcome of the check for plausibility, a different current signal peak is selected as the current axle signal peak or wherein all heights from a minimum height to a maximum height of the vehicle or vice versa are activated for calibration.

18. A sensor for height measurement in a vehicle comprising software for carrying out the method of claim 1.

19. A control unit comprising:
a processor;
a non-transitory computer readable medium having program code for height measurement in a vehicle having a height adjustment stored thereon;
wherein a sensor for height measurement is arranged on a chassis of the vehicle or is connected to the chassis at a defined distance, the sensor is arranged such that distances from an axle of the vehicle and from a ground below the vehicle can be detected;
said program code being configured, when executed by said processor, to:
via the sensor, transmit signals toward the axle and the ground, receive reflected signals and at least indirectly record intensities of the reflected signals and propagation times between the transmitted signals and the reflected signals as signal peaks, wherein the propagation times represent the distances of the sensor from the axle and also from the ground or can be converted into the distances;
said program code being, for calibration, further configured, when executed by said processor, to:
activate different heights of the vehicle by the height adjustment;
ascertain the propagation times and the signal intensities of the reflected signals for each height activated in the activation of different heights, such that a raw signal data set including the propagation times and the signal intensities of the signal peaks is obtained for each activated height;
identify signal peaks that always have the same propagation times irrespective of the activated height via the ascertained propagation times and signal intensities; and,
store a background data set yielded from the identified signal peaks that always have identical propagation times.

20. A vehicle comprising:
a height adjustment;
a chassis;
an axle;
a sensor for height measurement;
a control unit including a processor and a non-transitory computer readable medium having program code for height measurement in a vehicle having a height adjustment stored thereon;
said sensor being arranged on said chassis or being connected to said chassis at a defined distance, said sensor being arranged such that distances from said axle and from a ground below the vehicle can be detected;
said program code being configured, when executed by said processor, to:
via said sensor, transmit signals toward said axle and the ground, receive reflected signals and at least indirectly record intensities of the reflected signals and propagation times between the transmitted signals and the reflected signals as signal peaks, wherein the propagation times represent the distances of said sensor from said axle and also from the ground or can be converted into the distances;
said program code, for calibration, being further configured, when executed by said processor, to:
activate different heights of the vehicle by said height adjustment;
ascertain the propagation times and the signal intensities of the reflected signals for each height activated in the activation of different heights, such that a raw signal data set including the propagation times and the signal intensities of the signal peaks is obtained for each activated height;
identify signal peaks that always have the same propagation times irrespective of the activated height via the ascertained propagation times and signal intensities; and,
store a background data set yielded from the identified signal peaks that always have identical propagation times.
